(19) United States
(12) Patent Application Publication
(10) Pub. No.: US 2008/0104567 A1
(43) Pub. Date: May 1, 2008

(54) APPARATUS AND METHOD FOR ALLOCATING COMPONENT, AND COMPUTER READABLE MEDIUM

(75) Inventors: Shigeta Kuninobu, Kawasaki-Shi (JP); Keiichi Handa, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/924,820

(22) Filed: Oct. 26, 2007

(30) Foreign Application Priority Data
Oct. 27, 2006 (JP) 2006-292932

(51) Int. Cl. G06F 17/50

(52) U.S. Cl. 716/10

(57) ABSTRACT

There is provided an apparatus that creates a component allocation plan for an electronic apparatus including first and second allocation layers in which components are allocated, including: a storage configured to store first and second component information indicating sizes of a plurality of first components and a plurality of second components to be allocated in the first and second allocation layer; an allocation order determiner configured to determine first and second allocation orders in which the first and second components are allocated for each layer; an allocation strategy determiner configured to determine first and second allocation strategies by which the first and second components are allocated, which are different each other; and a component allocating unit configured to allocate the first and second components in the first and second allocation layer in accordance with the first and second allocation orders and the first and second allocation strategies.

### CROSS-REFERENCE TO RELATED APPLICATIONS

This application is based upon and claims the benefit of priority from the prior Japanese Patent Applications No. 2006-292932 filed on Oct. 27, 2006, the entire contents of which are incorporated herein by reference.

### BACKGROUND OF THE INVENTION

1. Field of the Invention

The present invention relates to an apparatus and a method for allocating components in an electronic apparatus having a plurality of component allocation layers in which the components should be allocated, and a computer readable medium.

2. Related Art

When designing an electronic apparatus, it is one of important issues how compactly components which make up the electronic apparatus are allocated in chassis. As restriction of component allocation in the electronic apparatus, there are determined layers to allocate components and an allocatable area of components. For example, electronic components allocated on a top surface of a substrate (board) belong to one layer and electronic components allocated on an bottom surface of the substrate belong to another layer. There is especially many restrictions for the allocatable are of components, for example, that terminal components need to be allocated at an edge of the chassis. When allocating components, it is preferable to perform allocation so that the height of the entire chassis becomes as small as possible. E. G. Coffman. Jr, M. R. Garey, D. S. Johnson, 1984, Approximation Algorithms for Bin-packing—An Updated Survey, Algorithm Design for Computer System Design, 1984, 49-106 describes a method of speedily deriving an approximate solution to a two-dimensional bin packing problem (problem to allocate components compactly) (since the bin packing problem is a problem that belongs to NP-hard, it takes an exponential time to derive an optimal solution) and William B. Dowsland, 1991, Three-dimensional Packing—Solution Approaches and Heuristic Development, International Journal of Production Research, Vol. 29, No. 8, 1673-1685 describes a method of speedily deriving an approximate solution to a three-dimensional bin packing problem. Neither of the documents considers restrictions on allocation of components or the like and is able to solve a case where electronic components subject to the above described restrictions on the area of allocation are allocated divided into a plurality of predetermined layers.

### SUMMARY OF THE INVENTION

According to an aspect of the present invention, there is provided with a component allocation apparatus that creates a component allocation plan for an electronic apparatus including at least a first allocation layer and a second allocation layer in which components are allocated, the first allocation layer and the second allocation layer being one of a top surface of a substrate in the electronic apparatus, a bottom surface of a substrate identical to or different from the substrate in the electronic apparatus, a top of a chassis of the electronics apparatus, a bottom of the chassis, and a whole of space in the chassis, and being different from each other, comprising:

a component information storage configured to store first component information indicating sizes of a plurality of first components to be allocated in the first allocation layer and second component information indicating sizes of a plurality of second components to be allocated in the second allocation layer;

an allocation order determiner configured to determine a first allocation order in which the first components are allocated and a second allocation order in which the second components are allocated;

an allocation strategy determiner configured to determine a first allocation strategy by which the first components are allocated and a second allocation strategy, which is different from the first allocation strategy, by which the second components are allocated; and

a component allocating unit configured to allocate the first components in the first allocation layer in accordance with the first allocation order and the first allocation strategy and allocate the second components in the second allocation layer in accordance with the second allocation order and the second allocation strategy.

According to an aspect of the present invention, there is provided with a component allocation method that creates a component allocation plan for an electronic apparatus including at least a first allocation layer and a second allocation layer in which components are allocated, the first allocation layer and the second allocation layer being one of a top surface of a substrate in the electronic apparatus, a bottom surface of a substrate identical to or different from the substrate in the electronic apparatus, a top of a chassis of the electronics apparatus, a bottom of the chassis, and a whole of space in the chassis, and being different from each other, comprising:

providing first component information indicating sizes of a plurality of first components to be allocated in the first allocation layer and second component information indicating sizes of a plurality of second components to be allocated in the second allocation layer;

determining a first allocation order in which the first components are allocated and a second allocation order in which the second components are allocated;

determining a first allocation strategy by which the first components are allocated and a second allocation strategy, which is different from the first allocation strategy, by which the second components are allocated; and

allocating the first components in the first allocation layer in accordance with the first allocation order and the first allocation strategy and allocate the second components in the second allocation layer in accordance with the second allocation order and the second allocation strategy.

According to an aspect of the present invention, there is provided with a computer readable medium storing a computer program executed by a computer creating a component allocation plan for an electronic apparatus including at least a first allocation layer and a second allocation layer in which components are allocated, the first allocation layer and the second allocation layer being one of a top surface of a substrate in the electronic apparatus, a bottom surface of a substrate identical to or different from the substrate in the electronic apparatus, a top of a chassis of the electronics apparatus, a bottom of the chassis, and a whole of space in the chassis, and being different from each other, the program comprising instructions to perform the steps of:

providing first component information indicating sizes of a plurality of first components to be allocated in the first allocation layer and second component information indicating sizes of a plurality of second components to be allocated in the second allocation layer;

determining a first allocation order in which the first components are allocated and a second allocation order in which the second components are allocated;

determining a first allocation strategy by which the first components are allocated and a second allocation strategy, which is different from the first allocation strategy, by which the second components are allocated; and

allocating the first components in the first allocation layer in accordance with the first allocation order and the first allocation strategy and allocate the second components in the second allocation layer in accordance with the second allocation order and the second allocation strategy.

### BRIEF DESCRIPTION OF THE DRAWINGS

FIG. 1 is a block diagram showing the configuration of a component allocation apparatus according to an embodiment of the present invention;

FIG. 2 is a flow chart illustrating operations of the component allocation apparatus in FIG. 1;

FIG. 3 illustrates an example of allocation strategies;

FIG. 4 shows allocation strategies and allocation order determined for each allocation layer;

FIG. 5 illustrates effects when components are allocated in descending order of area;

FIG. 6 illustrates a calculation of the sum of heights (height estimated value) at respective coordinate grid;

FIG. 7 shows a three-dimensional structure in process of creation; and

FIG. 8 shows a three-dimensional structure finally obtained.

### DETAILED DESCRIPTION OF THE INVENTION

This embodiment is intended to speedily create an allocation plan of compact components for an electronic apparatus (component allocation space) having a plurality of component allocation layers in which components are to be allocated. That is, the inside of the electronic apparatus is separated into a plurality of component allocation layers so as to treat it as a component allocation problem on a two-dimensional plane. Suppose width and depth (sizes in two-dimensional directions) of the respective component allocation layers are given beforehand. By making allocation strategies of components differ from one component allocation layer to another (making a method of packing components differ) and by changing the order in which components are allocated in each component allocation layer, a plan of component allocation is created such that when the respective component allocation layers are placed one atop another, the height becomes as low as possible. Hereinafter, this embodiment will be explained in detail.

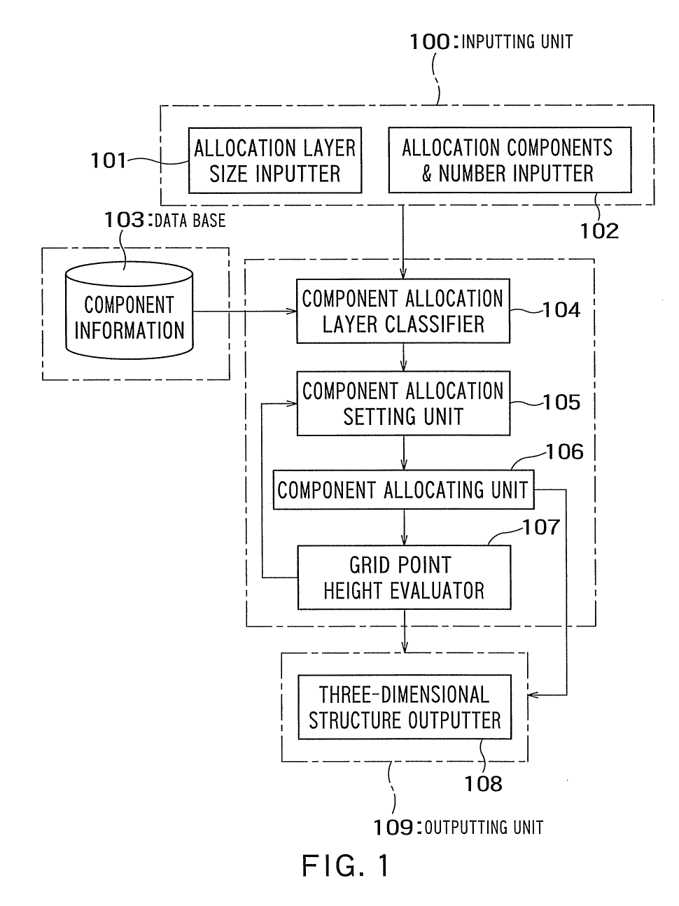

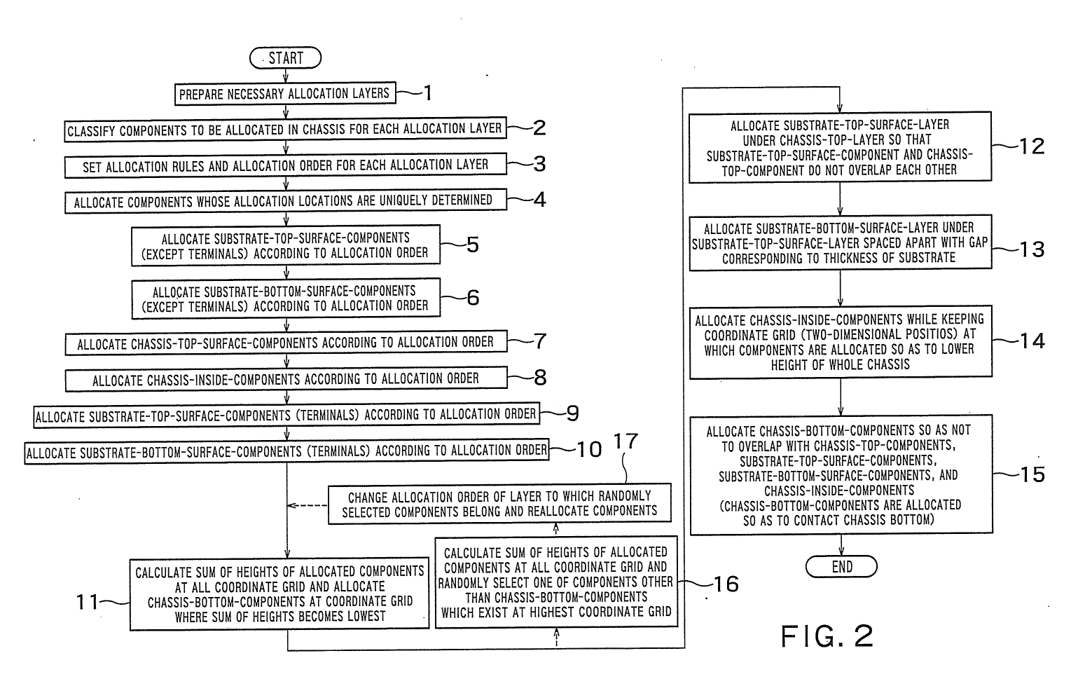

FIG. 1 is a block diagram showing the configuration of a component allocation apparatus according to an embodiment of the present invention. FIG. 2 is a flow chart illustrating operations of the component allocation apparatus in FIG. 1.

Hereinafter, an example of creating an allocation plan of main components of a notebook PC (Personal Computer) as an electronic apparatus will be explained using FIG. 1 and FIG. 2. The “main components” refer to relatively large-sized components making up the PC such as a CPU (Central Processing Unit), VGA (Video Graphics Array), keyboard, battery and hard disk drive. The width and depth (sizes in two-dimensional directions) of the notebook PC are defined by the specification and those values will be used.

First, in step 1, information on each component allocation layer in which components are to be allocated is inputted using allocation layer size inputter 101. As the information on the component allocation layer (hereinafter, simply referred to as an “allocation layer”), at least names (identifiers) and sizes (sizes in two-dimensional directions) thereof are inputted. When, for example, an allocation layer is the surface of a component allocation member, the thickness of the corresponding component allocation member may also be additionally inputted as component of the information.

Here, as the names of the allocation layers, four names of a substrate-top-surface-layer, substrate-bottom-surface-layer, chassis-top-layer and chassis-inner-layer are inputted and the same plane size is inputted as the size of each layer. This embodiment assumes that each layer has a rectangular plane shape, but the present invention is not limited to this and other plane shapes such as circle and ellipse may also be used.

The substrate-top-surface-layer is the layer where components to be mounted on the top surface of the substrate (substrate-top-surface-component) are allocated.

The substrate-bottom-surface-layer is the layer where the components to be mounted on the bottom surface of the substrate (substrate-bottom-surface-components) are allocated.

The chassis-top-layer is the layer where the components to be mounted on the chassis top in the chassis (chassis-top-components) are allocated.

The chassis-inner-layer is the layer to allocate components (chassis-inside-components) which can be allocated at any positions in the chassis (a whole of space).

Incidentally, in the embodiment, though it is supposed that one substrate is provided in the chassis, but it should be appreciated that one or more substrates may be provided in the chassis.

Furthermore, in this step 1, the names (identifiers) and the number of components to be allocated in the chassis of the notebook PC are inputted using an allocation components & number inputter 102. Here, the CPU, VGA, first terminals, memory device, MCH (Memory Controller Hub: north bridge), second terminals, keyboard, touch pad, speaker, battery, cooling fan, hard disk drive and DVD/CD-ROM drive are inputted as the names of the components. As for the number of components to be inputted, suppose the number of first terminals and second terminals are one or plural and the number of all other components is one. The allocation components & number inputter 102 and the allocation layer size inputter 101 are included in an inputting unit 100.

Here, a database 103 in FIG. 1 stores component information on each component to be allocated in the notebook PC. The component information contains the shape and size (length, width and height: size) of the component allocation layer in which the component is to be allocated and the area within which the component can be allocated in the allocation layer and includes at least the size (length, width and height: size). This embodiment defines the following contents as the allocation layer in which each component is to be allocated.

(1) Substrate-top-surface-layer: CPU, VGA, first terminals

(2) Substrate-bottom-surface-layer: Memory device, MCH, second terminals

(3) Chassis-top-layer: Keyboard, touch pad, speaker

(4) Chassis-inner-layer: Cooling fan, hard disk drive, DVD/CD-ROM drive

However, the above described battery is assumed to be a component to be mounted on the bottom of the chassis (chassis-bottom-component) in the chassis here and belongs to none of the above described four allocation layers. That is, since only one chassis-bottom-component is used in this embodiment, the battery may be allocated at a position where the height of the chassis becomes the lowest when the allocation of components in other allocation layers is completed, and therefore the chassis bottom layer is assumed not to be provided as the layer in which the chassis-bottom-components are allocated (not inputted from the allocation layer size inputter 101).

As the information on the above described allocatable area of each component, for example, such information is defined that the first and second terminals are allocatable to only the side and rear of the chassis in the respective allocation layers and the DVD/CD-ROM drive is allocatable to only the side/front (closer to the user) of the chassis in the allocation layer. Information that there is no restriction on allocatable locations may also be defined.

Here, as described above, this embodiment defines the relationship between each component and the allocation layer in which the component is allocated in the database 103, but instead this embodiment may also be adapted so that the user inputs information on the allocation layer in which each component should be allocated using the inputting unit 100.

Next, in step 2, a component allocation layer classifier 104 reads data from the database 103 and the inputting unit 101 and determines into which allocation layer each component should be classified. The relationship between the component and the allocation layer may be defined in the database 103 as described above or may be inputted by the user using inputting unit 100. The component allocation layer classifier 104 has a storage which at least temporarily stores the data read from the database 103 and the inputting unit 101.

Next, in step 3, a component allocation setting unit 105 determines, for each allocation layer, a component allocation strategy and an allocation order indicating from which component allocation is performed in order. That is, the component allocation setting unit 105 has an allocation order determiner and an allocation strategy determiner.

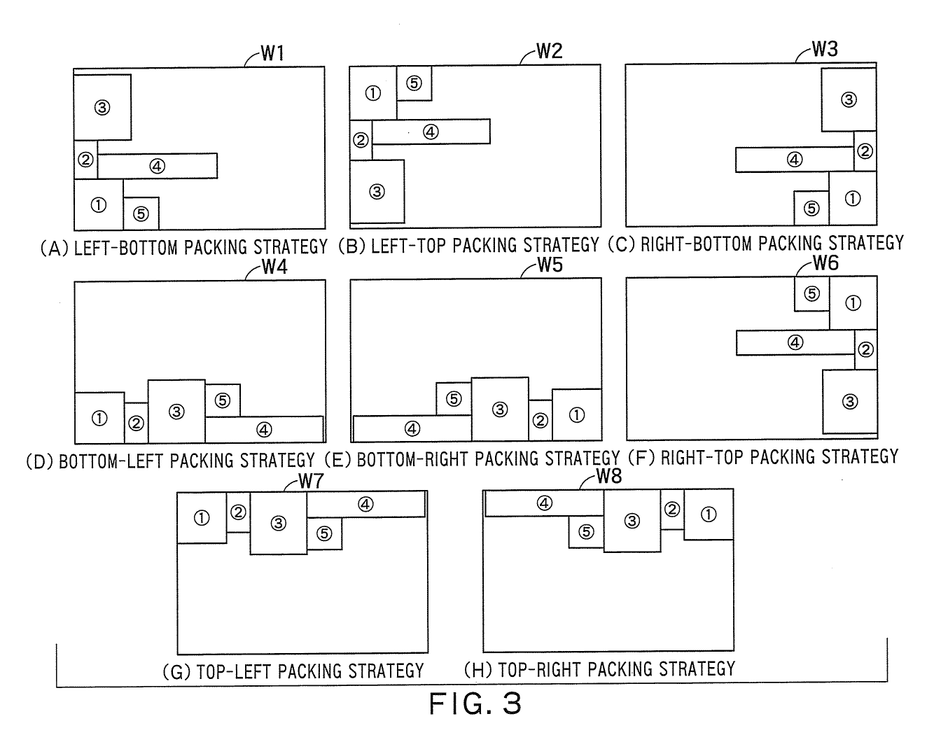

FIG. 3(A) to FIG. 3(H) show examples of allocation strategies. Large rectangular frames W1 to W8 represent a whole area when an arbitrary allocation layer is viewed two-dimensionally (as described above, each allocation layer has the same shape and size in this embodiment). Encircled numbers represent the order in which components are allocated (allocation order).

“Left-Bottom packing strategy” in FIG. 3(A) means packing components to the left side as much as possible and then packing components to the bottom side as much as possible.

“Left-Top packing strategy” in FIG. 3(B) means packing components to the left side as much as possible and then packing components to the top side as much as possible.

“Right-Bottom packing strategy” in FIG. 3(C) means packing components to the right side as much as possible and then packing components to the bottom side as much as possible.

“Bottom-Left packing strategy” in FIG. 3(D) means packing components to the bottom side as much as possible and then packing components to the left side as much as possible.

“Bottom-Right packing strategy” in FIG. 3(E) means packing components to the bottom side as much as possible and then packing components to the right side as much as possible.

“Right-Top packing strategy” in FIG. 3(F) means packing components to the right side as much as possible and then packing components to the top side as much as possible.

“Top-Left packing strategy” in FIG. 3(G) means packing components to the top side as much as possible and then packing components to the left side as much as possible.

“Top-Right packing strategy” in FIG. 3(H) means packing components to the top side as much as possible and then packing components to the right side as much as possible.

On the other hand, examples of the allocation order include a descending order of height, descending order of area and random order.

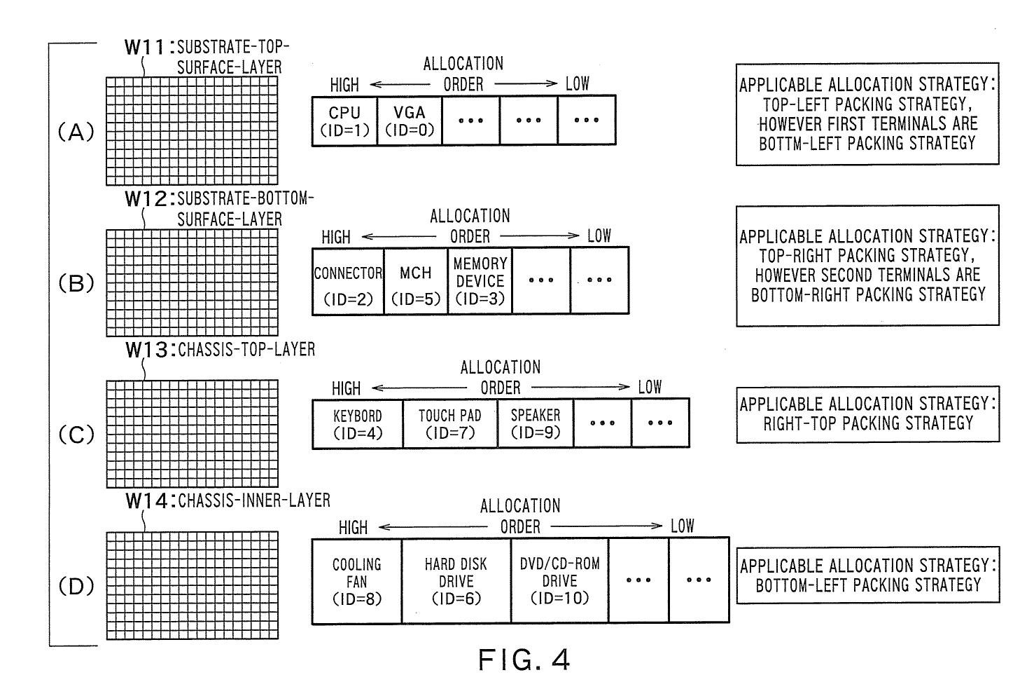

In this embodiment, suppose allocation strategies and allocation order are determined for each allocation layer as shown in FIG. 4(A) to FIG. 4(D).

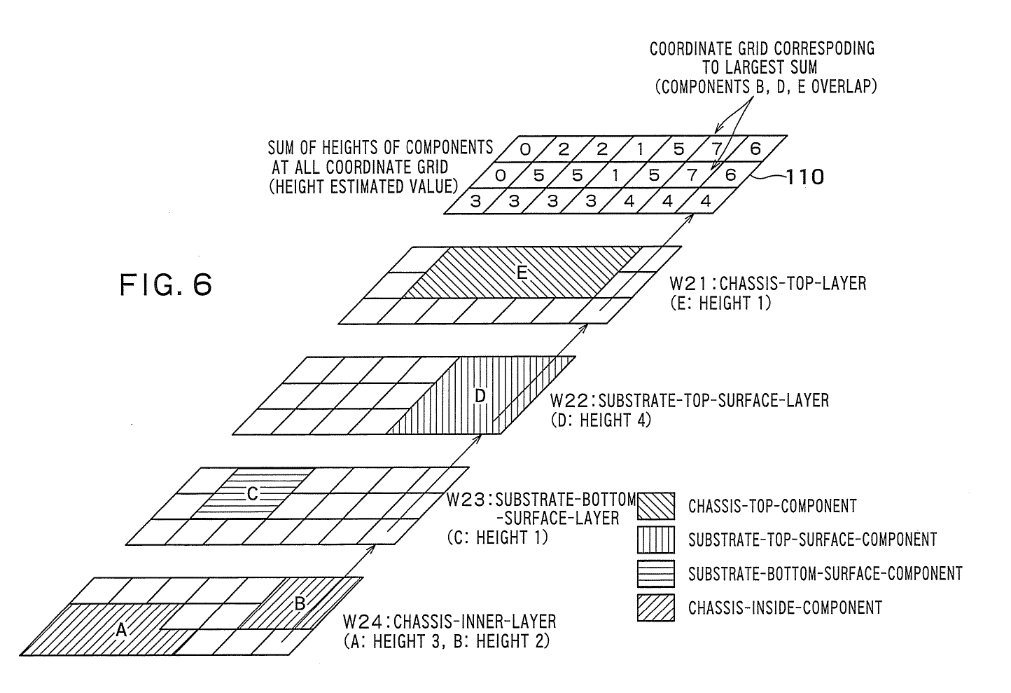

FIG. 4(A) shows the allocation strategy applicable to the substrate-top-surface-layer and the allocation order of components to be allocated in the substrate-top-surface-layer. “ID” is an identifier of each component. Illustrations of first terminals are omitted. “Top-Left packing strategy” is applied to the substrate-top-surface-layer except the first terminals and “Bottom-Left packing strategy” is applied to the first terminals (“Bottom-Left packing strategy” is applied to the first terminals in consideration of affinity for the user). The allocation order is CPU, VGA. W11 represents the plane area of the substrate-top-surface-layer. This two-dimensional area is divided in a grid pattern and the reason thereof will be explained later using FIG. 6.

FIG. 4(B) shows the allocation strategy applicable to the substrate bottom surface layer and the allocation order of components to be allocated in the substrate bottom surface layer. The connector is an example of second terminals. “Top-Right packing strategy” is applied to the substrate bottom surface layer except the second terminals and “Bottom-Right packing strategy” is applied to the second terminals (“Bottom-Right packing strategy” is applied to the second terminals in consideration of affinity for the user). W12 represents the plane area of the substrate bottom surface layer.

FIG. 4(C) shows the allocation strategy applicable to the chassis-top-layer and the allocation order of components to be allocated in the chassis-top-layer. “Right-Top packing strategy” is applied to the chassis-top-layer. W13 represents the plane area of the chassis-top-layer.

FIG. 4(D) shows the allocation strategy applicable to the chassis-inner-layer and the allocation order of components to be allocated in the chassis-inner-layer. “Bottom-Left packing strategy” is applied to the chassis-inner-layer. W14 represents the plane area of the substrate inner layer. As described above, the shapes and sizes of the plane areas represented by W11 to W14 are the same.

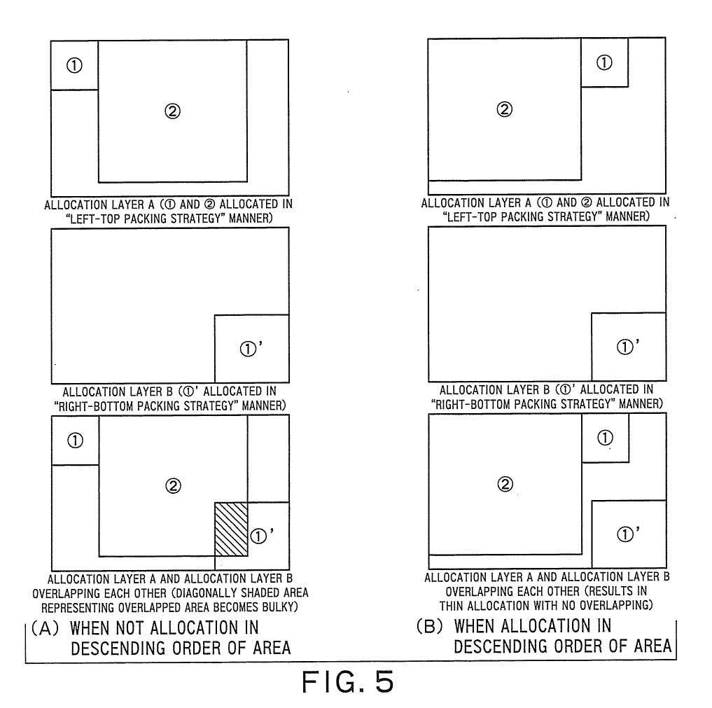

In order to prevent components from concentrating on the same locations (coordinate grid) among the respective allocation layers as much as possible to make the height of the chassis as low as possible, allocation strategies applicable to the respective allocation layers are made to differ from each other. However, overlapping of the allocation strategies is permitted from the standpoint of affinity for the user, and the allocation strategy of the first terminals in the chassis-top-layer and the allocation strategy of the chassis-inner-layer overlap each other. Furthermore, it is possible to realize effective component allocation by making the allocation strategies differ from one allocation layer to another and adopting a descending order of height or descending order of area as the allocation order in this way. FIG. 5(A) and FIG. 5(B) show allocation examples in the latter case. When allocation is not performed in descending order of area as in the case of FIG. 5(A), components overlap each other between an allocation layer A and an allocation layer B, which causes the chassis to become thicker, but allocating components in descending order of area as shown in FIG. 5(B) reduces the overlapping of components between the allocation layers.

Next, in step 4, a component allocating unit 106 allocates components whose allocation locations are uniquely determined at the corresponding locations in the respective allocation layers. In this embodiment, the keyboard and touch pad are assumed to correspond to such components and are allocated at the specified locations in the chassis-top-layer respectively.

In next step 5, the component allocating unit 106 allocates components to be allocated in the substrate-top-surface-layer except the first terminals according to the allocation strategy and allocation order set by the component allocation setting unit 105. That is, the component allocating unit 106 allocates the CPU and VGA in that order in the “Top-Left packing strategy” manner. The component allocating unit 106 allocates those components in such a way that they do not overlap each other in the substrate-top-surface-layer.

Next, in step 6, the component allocating unit 106 allocates the components to be allocated in the substrate-bottom-surface-layer except the second terminals according to the allocation strategy and allocation order set by the component allocation setting unit 105. That is, the component allocating unit 106 allocates an MCH and a memory device in that order in the “Top-Right packing strategy” manner. The component allocating unit 106 allocates those components so that they do not overlap each other in the substrate-bottom-surface-layer.

Next, in step 7, the components to be allocated in the chassis-top-layer are allocated according to the allocation strategy and allocation order set by the component allocation setting unit 105. That is, the speaker is allocated in the “Right-Top packing strategy” manner. The keyboard and the touch pad have already been allocated in step 4. At the time of allocation, those components are allocated so as not to overlap with other components in the chassis-top-layer.

Next, in step 8, the components to be allocated in the chassis-inner-layer are allocated according to the allocation strategy and the allocation order set by the component allocation setting unit 105. That is, the cooling fan, hard disk drive and DVD/CD-ROM drive are allocated in that order in the “Bottom-Left packing strategy” manner. The respective components are allocated so as not overlap each other in the allocation layer except the chassis-inner-layer, but suppose overlapping of the components is permitted in the chassis-inner-layer. However, in the case of allocation where a “standard height of the chassis” preset by the user is exceeded when the components overlap each other, the overlapping is not permitted. The “standard height of the chassis” may be set as a fixed value or determined using a maximum value of the height estimated value in process of allocation (see FIG. 6 which will be described later). The details about this will be described later.

Next, in step 9, the first terminals of the components to be allocated in the substrate-top-surface-layer are allocated according to the allocation strategy and the allocation order set by the component allocation setting unit 105. That is, the first terminals are allocated in the substrate-top-surface-layer in the “Bottom-Left packing strategy” manner. At the time of allocation, the respective components are allocated so as not to overlap each other in the substrate-top-surface-layer. When the components in the chassis-inner-layer have already been allocated at the same positions (layers are different but the coordinate grid are the same) and the set “standard height of the chassis” above is exceeded, the components are allocated so as not to overlap the components in the chassis-inner-layer.

Next, in step 10, the second terminals of the components to be allocated in the substrate-bottom-surface-layer are allocated according to the allocation strategy and the allocation order set by the component allocation setting unit 105. That is, the second terminals are allocated in the “Bottom-Right packing strategy” manner. At the time of allocation, the respective components are allocated so as not to overlap each other in the substrate-bottom-surface-layer. However, in the case where the components in the chassis-inner-layer have already been allocated at the same positions (layers are different but the coordinate grid are the same) and the set “standard height of the chassis” above is exceeded, the components are allocated so as not to overlap with those components.

Next, in step 11, a grid point height evaluator 107 calculates the sum of heights (height estimated value) of all components which exist at the coordinate grid for each grid point (coordinate grid). The coordinate grid at which the minimum sum or the sum of heights (height estimated value) equal to or below a threshold is obtained are calculated and the chassis-bottom-components are allocated in the area of the calculated coordinate grid. How the sum of heights (height estimated value) at the respective coordinate grid is calculated will be explained using FIG. 6.

In FIG. 6, a chassis-top-layer W21, substrate-top-surface-layer W22, substrate-bottom-surface-layer W23 and chassis-inner-layer W24 are each divided two-dimensionally in a grid pattern so as to have the same number (21) of grid points. A component having height 1 is allocated in an area E shown in the figure on the chassis-top-layer W21. In the same way, a component having height 4 is allocated in an area D on the substrate-top-surface-layer W22, a component having height 1 is allocated in an area C on the substrate-bottom-surface-layer W23, a component having height 3 is allocated in an area A and a component having height 2 is allocated in an area B in the chassis-inner-layer W24. By summing up the heights of components at the same coordinate grid in the allocation layers W21 to W24, height evaluation data 110 indicating the sum of heights (height estimated value) of the components at each of the coordinate grid is obtained. Using this height evaluation data 110, the coordinate grid at which the lowest sum or the sum of heights (height estimated value) equal to or lower than a threshold is obtained when the chassis-bottom-components are allocated are calculated and the chassis-bottom-components are allocated at the calculated coordinate grid.

The allocation of components in each allocation layer ends using the procedure hitherto. Next, to output a three-dimensional structure (chassis design plan), a three-dimensional structure outputter 108 performs processes in step 12 to step 15. The three-dimensional structure outputter 108 is included in an outputting unit 109. The three-dimensional structure outputter 108 corresponds to, for example, a layer position adjusting unit and a component position adjusting unit.

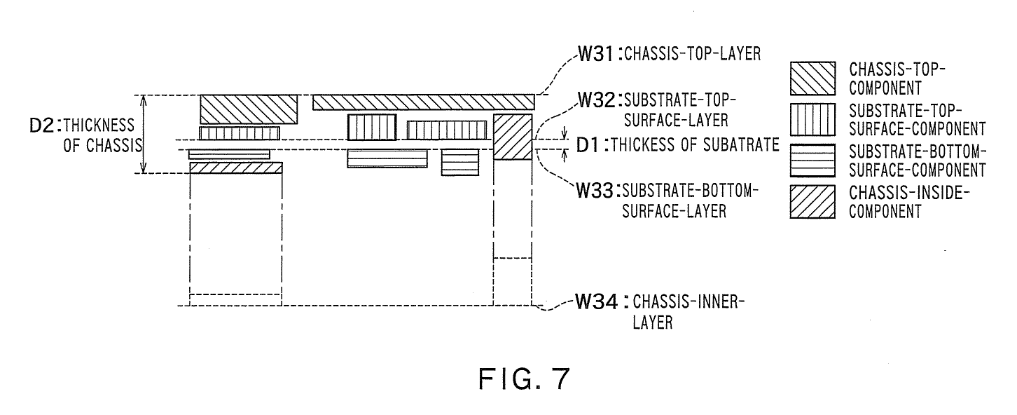

First, in step 12, as shown in FIG. 7, a substrate-top-surface-layer W32 is allocated below a chassis-top-layer W31 in such a way that the chassis surface components and the substrate-top-surface-components do not overlap each other. That is, the chassis-top-layer W31 and the substrate-top-surface-layer W32 are placed face to face and the relative position of the chassis-top-layer W31 and the substrate-top-surface-layer W32 is adjusted in the direction parallel to the layering direction (upward or downward direction parallel to the plane of the sheet).

Next, in step 13, a substrate-bottom-surface-layer W33 is allocated under the substrate-top-surface-layer W32 spaced apart with a gap D1 which corresponds to the thickness of the substrate.

Next, in step 14, the respective components inside the chassis allocated in a chassis-inner-layer W34 are allocated so as not to overlap with other components (may contact other components) while keeping their coordinate grid (two-dimensional positions) independently of each other. In this case, the components are allocated in such a way that the height of the entire chassis (thickness of the chassis) becomes as low as possible.

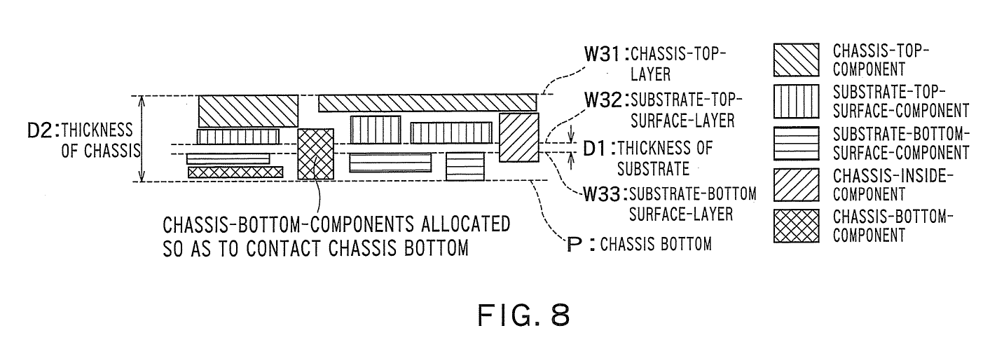

Finally, in step 15, as shown in FIG. 8, the chassis-bottom-components are allocated on a bottom surface (chassis bottom) P so as not to overlap with the chassis-top-components, substrate-top-surface-components, substrate-bottom-surface-components and components inside the chassis. Since these are the last allocation components, the position where the height of the chassis becomes lowest can be extracted from the allocation positions of other components. As described above, a final three-dimensional structure (chassis design plan) is obtained. The final thickness of the chassis in this embodiment is indicated by D2.

When obtaining a plurality of chassis design plans, after completing step 11, the process moves to step 16 and the grid point height evaluator 107 calculates the sum of heights (height estimated value) at the respective coordinate grid (excluding the chassis-bottom-components). This calculation has already been carried out in step 11, and so this calculation result may be used as is. Next, one of the components other than the chassis-bottom-components at the highest coordinate grid is selected. The component can be selected randomly or an allocation order may be set in each allocation layer beforehand and the component may be selected following this allocation order. In the case of the example in FIG. 6, the components B, D, E allocated at the coordinate grid having 7 which is the largest sum (height estimated value) are candidates to be selected.

In step 17, the component allocation setting unit 105 changes the allocation order of the allocation layer to which the component selected by the grid point height evaluator 107 belongs and does over allocation of the components in the allocation layer in question. This allows different allocations to be obtained in the allocation layer in question. Hereinafter, it is possible to obtain a three-dimensional structure (chassis design plan) which differs from the above described one by executing the processes in step 11 to step 15 once again.

The explanation of above described step 8 has described that overlapping of the respective components is permitted when components are allocated in the chassis-inner-layer, whereas in the case of allocation that exceeds the “standard height of the chassis” preset by the user, the overlapping is not permitted. The explanation has also described that a fixed value may be set as the standard height of the chassis or the standard height may be determined using the height estimated value in process of allocation (see FIG. 6). This will be explained in further detail below.

When components are allocated in the chassis-inner-layer, overlapping among the respective components on the two-dimensional plane is permitted, but when components are allocated intensively at the same location, there is a problem that the chassis becomes bulky when those components are three-dimensionally developed. Therefore, a concept of “standard height of the chassis” is introduced and suppose allocation exceeding the standard height of the chassis will not be permitted.

The setting of the standard height of the chassis may be a fixed value as described above or a maximum value of the height estimated value in process of allocation may also be used.

When the standard height of the chassis is given with a fixed value, the standard height of the chassis corresponds to the final thickness of the PC (which corresponds to the thickness D2 of the chassis shown in FIG. 7 and FIG. 8) conceived by the PC designer. The height to be compared with the standard height of the chassis is the height estimated value in FIG. 6.

Therefore, when the standard height of the chassis is given with a fixed value, as for the question whether or not overlapping is permitted, components are provisionally allocated first and a height estimated value (maximum value when the area extends over a plurality of coordinate grid) of the area (one or a plurality of coordinate grid) occupied by the component is calculated. When the height estimated value (assumed to be h1) of the area occupied by the component and the standard height (assumed to be h2) of the chassis satisfy a relation of “h1≦h2”, the allocation at that location is permitted. On the other hand, if this relation is not satisfied, the allocation is not permitted and the next allocation candidate will be searched based on the allocation strategy. For example, a location resulting from shifting the original location by one coordinate according to the allocation strategy is determined as the next allocation candidate (however, this location must belong to the allocatable area). In the case where a component previously judged as one for which overlapping is not permitted is allocated at the determined allocation candidate location, it is preferable, from the standpoint of processing efficiency, to shift the coordinates to a location that does not overlap the component in question based on the allocation strategy.

On the other hand, the standard height of the chassis using the maximum value of the height estimated value in process of allocation is given by “h3×coefficient k” when the maximum value of the height estimated value is assumed to be h3 in process of certain allocation (before allocating the target component). The coefficient k is preset by the PC designer, for example. Assuming that a component is provisionally allocated at a certain location and a height estimated value (a maximum one when the area extends over a plurality of coordinate grid) of the area occupied by the component in question (one or a plurality of coordinate grid) is h4, the component is allocated at that location if a relation “h4≦h3×coefficient k” is satisfied. On the other hand, when this relation is not satisfied, the next allocation candidate location is searched according to the allocation strategy. Determining the standard height of the chassis using the maximum value of the height estimated value in process of allocation is effective when it is preferred to perform thin allocation speedily without considering the final thickness of the PC conceived by the PC designer.

A location where the height estimated value simply decreases may be searched and components may be allocated without introducing the concept of a standard height of the chassis, but all locations need to be searched and this takes time. On the other hand, when the concept of a standard height is introduced, allocation is completed at a time point at which a specific condition (the above described inequality or the like) is satisfied is found, and it is thereby possible to realize speedy allocation.

As for the allocation of the first terminals in step 9 above and the allocation of the second terminals in step 10, it has also been described that when those terminals overlap with components in the chassis-inner-layer, the terminals should be allocated so that the standard height of the chassis is not exceeded, and a judgment will be made on these terminals using a technique similar to the above described one.

The component allocation apparatus of this embodiment may also be realized using a general-purpose computer device as basic hardware. That is, the component allocation layer classifier 104, component allocation setting unit 105, component allocating unit 106, grid point height evaluator 107 and three-dimensional structure outputter 108 can be realized by causing a processor mounted in the above described computer device to execute a program. In this case, the component allocation apparatus may be realized by installing the above described program in the computer device beforehand or may be realized by storing the program in a storage medium such as a CD-ROM or distributing the above described program over a network and installing this program in the computer device as appropriate. Furthermore, the database 103 may also be realized using a memory device or hard disk incorporated in or externally added to the above described computer device or a storage medium such as CD-R, CD-RW, DVD-RAM, DVD-R as appropriate.

What is claimed is:

1. A component allocation apparatus that creates a component allocation plan for an electronic apparatus including at least a first allocation layer and a second allocation layer in which components are allocated, the first allocation layer and the second allocation layer being one of a top surface of a substrate in the electronic apparatus, a bottom surface of a substrate identical to or different from the substrate in the electronic apparatus, a top of a chassis of the electronics apparatus, a bottom of the chassis, and a whole of space in the chassis, and being different from each other, comprising:
a component information storage configured to store first component information indicating sizes of a plurality of first components to be allocated in the first allocation layer and second component information indicating sizes of a plurality of second components to be allocated in the second allocation layer;
an allocation order determiner configured to determine a first allocation order in which the first components are allocated and a second allocation order in which the second components are allocated;
an allocation strategy determiner configured to determine a first allocation strategy by which the first components are allocated and a second allocation strategy, which is different from the first allocation strategy, by which the second components are allocated; and
a component allocating unit configured to allocate the first components in the first allocation layer in accordance with the first allocation order and the first allocation strategy and allocate the second components in the second allocation layer in accordance with the second allocation order and the second allocation strategy.

2. The apparatus according to claim 1, wherein the first component information further defines an allocatable area in the first allocation layer for each of the first components, and
the component allocating unit allocates the first components within respective allocatable areas.

3. The apparatus according to claim 2, wherein the second component information further defines an allocatable area in the second allocation layer for each of the second components, and
the component allocating unit allocates the second components within respective allocatable areas.

4. The apparatus according to claim 1, wherein at least any one of the first allocation order and the second allocation order is a descending order of heights of the components.

5. The apparatus according to claim 1, wherein at least one of the first allocation order and the second allocation order is a descending order of allocation area of the components.

6. The apparatus according to claim 1, wherein when the first allocation layer is two-dimensionally viewed, the first allocation strategy is any one of
a Left-Top packing strategy which defines to pack components to a left side as much as possible and then pack components to a top side as much as possible,
a Left-Bottom packing strategy which defines to pack components to the left side as much as possible and then pack components to a bottom side as much as possible,
a Right-Top packing strategy which defines to pack components to a right side as much as possible and then pack components to the top side as much as possible,
a Right-Bottom packing strategy which defines to pack components to the right side as much as possible and then pack components to the bottom side as much as possible,
a Top-Left packing strategy which defines to pack components to the top side as much as possible and then pack components to the left side as much as possible,
a Top-Right packing strategy which defines to pack components to the top side as much as possible and then pack components to the right side as much as possible,
a Bottom-Left packing strategy which defines to pack components to the bottom side as much as possible and then pack components to the left side as much as possible and
a Bottom-Right packing strategy which defines to pack components to the bottom side as much as possible and then pack components to the right side as much as possible, and
the second allocation strategy is any one of the Left-Top packing strategy, the Left-Bottom packing strategy, the Right-Top packing strategy, the Right-Bottom packing strategy, the Top-Left packing strategy, the Top-Right packing strategy, the Bottom-Left packing strategy and the Bottom-Right packing strategy, which is different from the first allocation strategy when the second allocation layer is two-dimensionally viewed.

7. The apparatus according to claim 1, further comprising a height evaluator configured to
calculate, when the first and second allocation layers are two-dimensionally divided in a grid pattern, sums of heights of components which exist at same coordinate grid,
identify coordinate grid at which the sum is equal to or greater than a threshold or highest coordinate grid,
select either the first allocation layer or the second allocation layer in which the component exists at identified coordinate grid and
instruct the allocation order determiner to change the allocation order in a selected allocation layer.

8. The apparatus according to claim 1, further comprising an layer position adjusting unit configured to adjust a relative position of the first and second allocation layers in a direction parallel to the layering direction.

9. The apparatus according to claim 1, further comprising an component position adjusting unit configured to adjust the positions of the second components in the second allocation layer in a direction parallel to the layering direction of the first and second allocation layers.

10. A component allocation method that creates a component allocation plan for an electronic apparatus including at least a first allocation layer and a second allocation layer in which components are allocated, the first allocation layer and the second allocation layer being one of a top surface of a substrate in the electronic apparatus, a bottom surface of a substrate identical to or different from the substrate in the electronic apparatus, a top of a chassis of the electronics apparatus, a bottom of the chassis, and a whole of space in the chassis, and being different from each other, comprising:
providing first component information indicating sizes of a plurality of first components to be allocated in the first allocation layer and second component information indicating sizes of a plurality of second components to be allocated in the second allocation layer;
determining a first allocation order in which the first components are allocated and a second allocation order in which the second components are allocated;
determining a first allocation strategy by which the first components are allocated and a second allocation strategy, which is different from the first allocation strategy, by which the second components are allocated; and
allocating the first components in the first allocation layer in accordance with the first allocation order and the first allocation strategy and allocate the second components in the second allocation layer in accordance with the second allocation order and the second allocation strategy.

11. A computer readable medium storing a computer program executed by a computer creating a component allocation plan for an electronic apparatus including at least a first allocation layer and a second allocation layer in which components are allocated, the first allocation layer and the second allocation layer being one of a top surface of a substrate in the electronic apparatus, a bottom surface of a substrate identical to or different from the substrate in the electronic apparatus, a top of a chassis of the electronics apparatus, a bottom of the chassis, and a whole of space in the chassis, and being different from each other, the program comprising instructions to perform the steps of:
providing first component information indicating sizes of a plurality of first components to be allocated in the first allocation layer and second component information indicating sizes of a plurality of second components to be allocated in the second allocation layer;
determining a first allocation order in which the first components are allocated and a second allocation order in which the second components are allocated;
determining a first allocation strategy by which the first components are allocated and a second allocation strategy, which is different from the first allocation strategy, by which the second components are allocated; and
allocating the first components in the first allocation layer in accordance with the first allocation order and the first allocation strategy and allocate the second components in the second allocation layer in accordance with the second allocation order and the second allocation strategy.
